(19) United States
(12) Patent Application Publication
(10) Pub. No.: US 2018/0285784 A1
(43) Pub. Date: Oct. 4, 2018

(54) Systems and Methods for Providing Near Best Itinerary Planning for Touring Locations Based on User Interests.

(71) Applicant: Harish K. Kashyap, Karnataka (IN)

(72) Inventor: Harish K. Kashyap, Karnataka (IN)

(21) Appl. No.: 15/473,720

(22) Filed: Mar. 30, 2017

(51) Int. Cl. G06Q 10/02

(52) U.S. Cl. CPC G06Q 10/025; G06Q 50/14

(57) ABSTRACT

Embodiments of the present invention are related to systems and methods for generating travel itineraries. Specifically, embodiments of the present invention are directed at automated system and methods for generating travel itineraries based on user interests as well as tour duration and availability and distance from relevant points of interests (POIs). Preferred embodiments of the invention are configured to generate optimal travel itineraries for users with limited tour time that may not otherwise allow for visitation of all POIs on a given trip.

### FIELD OF THE INVENTION

Embodiments of the present invention are related to systems and methods for generating travel itineraries. Specifically, embodiments of the present invention are directed at automated system and methods for generating travel itineraries based on user interests as well as tour duration and availability and distance from relevant points of interests (POIs). Preferred embodiments of the invention are configured to generate optimal travel itineraries for users with limited tour time that may not otherwise allow for visitation of all POIs on a given trip.

### BACKGROUND

Travel planning has long been a complex task. Previously, some form of self-driven planning or assisted planning (e.g., via travel agencies) has been the go to method for developing suitable itineraries for tour and travel based excursions.

There are many failings to these methods, one of which is the lack of an entire set of knowledge required to determine what points of interest an individual would want to visit given a specific location or region for travel. For instance, most individuals desiring to travel to a location have never been to that actual location before. Therefore the knowledge they have of the area is limited to second hand knowledge and other knowledge derived from one or more sources that have an unknown amount of expertise on the location. Without having expert and up to date knowledge on a location and the points of interest at that location, it is difficult to plan an itinerary that ensures an optimal experience.

A second failing is that given points of interest may be distal from one another, take a varying amount of time to enjoy or fully consume, and have other parameters, such as times of operation and accessibility to transportation means, ensuring that an itinerary is ideal and optimal becomes difficult as there are a multitude of variables to account for, many of which may be dynamic variables in and of themselves.

Therefore there is a need in the art for a system and method for generating travel itineraries based on user interests, while taking into account data and variables associated with a plurality of points of interests and duration of a tour to be conducted. These and other features and advantages of the present invention will be explained and will become obvious to one skilled in the art through the summary of the invention that follows.

### SUMMARY OF THE INVENTION

Accordingly, it is an object of the present invention to for generating travel itineraries based on user interests, while taking into account data and variables associated with a plurality of points of interests and duration of a tour to be conducted.

According to an embodiment of the present invention, a system for generating travel itineraries based on user interests comprises: a computer processor; a non-volatile computer-readable memory; and a data receiving interface, wherein the non-volatile computer-readable memory is communicatively connected to said processor and data receiving interface and is configured with computer instructions configured to: receive an itinerary generation request from a user; process a set of one or more user attraction interests from said itinerary generation request; process a tour duration from said itinerary generation request, wherein said tour duration indicates the temporal duration of a tour to be taken by said user at a future time; retrieve a plurality of potential points of interests, wherein each potential point of interest in said plurality of points of interest corresponds to at least one user attraction interest of said set of one or more user attraction interests; generate a plurality of point of interest clusters based on said plurality of potential points of interests; generate near best distance solution between said plurality of points of interest clusters; generate a preferred itinerary, based at least in part on said near best distance solution; and transmitting said preferred itinerary to said user.

According to an embodiment of the present invention, the non-volatile computer-readable memory is further configured with computer instructions configured to identify one or more modes of travel associated with said itinerary generation request, wherein said one or more modes of travel are utilized in generating said preferred itinerary.

According to an embodiment of the present invention, said one or more modes of travel are utilized to identify best methods of travel between one or more of said plurality of point of interest clusters.

According to an embodiment of the present invention, the non-volatile computer-readable memory is further configured with computer instructions configured to generate one or more visual possible itineraries based at least in part on said near best distance solution; provide said one or more visual possible itineraries to said user; receive from the user a selected visual possible itinerary from said user, wherein said selected visual possible itinerary was selected from said one or more visual possible itineraries; and utilize said selected visual possible itinerary in generation of said preferred itinerary.

According to an embodiment of the present invention, the non-volatile computer-readable memory is further configured with computer instructions configured to retrieve additional information about one or more of said potential points of interest.

According to an embodiment of the present invention, additional information about one or more said potential points of interest comprises, hours of operation, best times to visit, popular times to visit, dress code, expense, access to public transit, special offers and average duration of visit.

According to an embodiment of the present invention, the non-volatile computer-readable memory is further configured with computer instructions configured to eliminate one or more potential points of interests from said plurality of potential points of interests.

According to an embodiment of the present invention, the non-volatile computer-readable memory is further configured with computer instructions configured to organize said preferred itinerary based in part on said additional information about one or more said potential points of interest.

According to an embodiment of the present invention, the non-volatile computer-readable memory is further configured with computer instructions configured to generate a convex hull that is used for visualizing the boundaries of the previously generated points of interest clusters.

According to an embodiment of the present invention, a method for generating travel itineraries based on user interests comprises the steps of: receiving an itinerary generation request from a user; processing a set of one or more user attraction interests from said itinerary generation request; processing a tour duration from said itinerary generation request, wherein said tour duration indicates the temporal duration of a tour to be taken by said user at a future time; retrieving a plurality of potential points of interests, wherein each potential point of interest in said plurality of points of interest corresponds to at least one user attraction interest of said set of one or more user attraction interests; generating a plurality of point of interest clusters based on said plurality of potential points of interests; generating near best distance solution between said plurality of points of interest clusters; generating a preferred itinerary, based at least in part on said near best distance solution; and transmitting said preferred itinerary to said user.

According to an embodiment of the present invention, the method further comprises the step of: identifying one or more modes of travel associated with said itinerary generation request, wherein said one or more modes of travel are utilized in generating said preferred itinerary.

According to an embodiment of the present invention, the method further comprises the steps of: generating one or more visual possible itineraries based at least in part on said near best distance solution; providing said one or more visual possible itineraries to said user; receiving from the user a selected visual possible itinerary from said user, wherein said selected visual possible itinerary was selected from said one or more visual possible itineraries; and utilizing said selected visual possible itinerary in generation of said preferred itinerary.

According to an embodiment of the present invention, the method further comprises the step of retrieving additional information about one or more of said potential points of interest.

According to an embodiment of the present invention, the method further comprises the step of eliminating one or more potential points of interests from said plurality of potential points of interests.

According to an embodiment of the present invention, the method further comprises the steps of organizing said preferred itinerary based in part on said additional information about one or more said potential points of interest.

### BRIEF DESCRIPTION OF THE DRAWINGS

FIG. 1 illustrates an exemplary process flow for generating travel itineraries based on user interests;

FIG. 2 illustrates an exemplary process flow for generating travel itineraries based on user interests;

FIG. 3 illustrates an exemplary process flow for generating travel itineraries based on user interests;

FIG. 4 illustrates a schematic overview of a computing device, in accordance with an embodiment of the present invention;

FIG. 5 illustrates a schematic overview of an embodiment of a system for generating travel itineraries based on user interests;

FIG. 6 illustrates a schematic overview of an embodiment of a system for generating travel itineraries based on user interests;

FIG. 7 is an illustration of a network diagram for a cloud based portion of the system, in accordance with an embodiment of the present invention;

FIG. 8 is an illustration of a network diagram for a cloud based portion of the system, in accordance with an embodiment of the present invention;

FIG. 9A is an illustration of a graphical user interface depicting an exemplary generated travel itinerary, in accordance with an embodiment of the present invention;

FIG. 9B is an illustration of a graphical user interface depicting an exemplary generated travel itinerary, in accordance with an embodiment of the present invention; and

FIG. 9C is an illustration of a graphical user interface depicting an exemplary generated travel itinerary, in accordance with an embodiment of the present invention.

### DETAILED SPECIFICATION

Embodiments of the present invention are related to systems and methods for generating travel itineraries. Specifically, embodiments of the present invention are directed at automated system and methods for generating travel itineraries based on user interests as well as tour duration and availability and distance from relevant points of interests (POIs). Preferred embodiments of the invention are configured to generate optimal travel itineraries for users with limited tour time that may not otherwise allow for visitation of all POIs on a given trip.

According to an embodiment of the present invention, the system and methods detailed herein leverage certain aspects of artificial intelligence and machine learning to generate itineraries for tours (e.g., city tours, rural tours). Since time is generally limited for touring, the systems and methods detailed herein leverage machine learning methods to identify pragmatic itineraries and tailored tours for preferences associated with specific users and individuals.

Some travelers are interested more in certain attractions such as parks and less interested in religious places and hence would like spend time accordingly. In accordance with an embodiment of the present invention, the system is configured to receive and store information from users related to particular interests each user has. Interest information could include, but is not limited to, information about types of points of interests (POIs) that the user prefers, selection of specific POIs, information about preferred times of touring (e.g., morning, afternoon, evening), information about restrictions (e.g., dietary, religious, travel), or any combination thereof. One of ordinary skill in the art would appreciate that there are numerous types of interest information that could be utilized with embodiments of the present invention, and embodiments of the present invention are contemplated for use with any appropriate types of interest information.

According to an embodiment of the present invention, in generating an itinerary, the system considers all constraints such as total tour time, average time at various types of attractions and/or current location, and interest information provided by the user. With these parameters set or otherwise provided, a near best itinerary suggestion may be provided to the user for confirmation prior to generation of the full itinerary.

According to a preferred embodiment of the present invention, density based scanning is performed initially and tuned to find suitable clusters of POIs. A POI cluster is an area identified by the system where a plurality of POIs are located proximate to one another. Since POIs could be distributed all over a potential tour area, clustering of POIs assists with the ability to schedule an optimal tour and related itinerary for that tour.

Further, in a preferred embodiment of the present invention, a near best distance between such POI clusters is computed that is pragmatic but may/may not be the best total distance is suggested. This helps reduce time complexity while increasing the distance slightly leading to a pragmatic approximate solution.

In certain locations, the system may be configured to identify and process, in conjunction with the formation of itineraries, available modes of travel in the tour area, such as cars, trains, busses, light rail, subways, bicycles and walking. In this manner, the system can be configured to analyze and provide itinerary travel between POIs based on optimal modes of travel between two locations, even dependent on travel at specific times of the day (e.g., it may be quicker to take a subway than drive during certain high traffic times). Advantageously, the system considers time taken via such modes of travel and utilizes this information for generation of optimal itineraries.

According to certain embodiments of the present invention, the system may be configured to take into account variables associated with one or more POIs when determining an optimal itinerary. For instance, one important consideration for various POIs is times that a POI is actually open. This includes not just an opening and closing time, but times where the POI might be intermittently closed (e.g., seasonally, mid-day closures). Further, the system may take into account other variables associated with a POI, such as best times to visit the POI (e.g., sunset, sunrise, midday), popular times to visit the POI, least busy times to visit the POI, or any combination thereof. One of ordinary skill in the art would appreciate that there are numerous types of variables that could be utilized with embodiments of the present invention, and embodiments of the present invention are contemplated for use with any appropriate variable. In a preferred embodiment of the present invention, the system may be augmented by interacting with third-party systems in order to retrieve up to date information about these variables, such as via an application programming interface (API) provided by a third-party system.

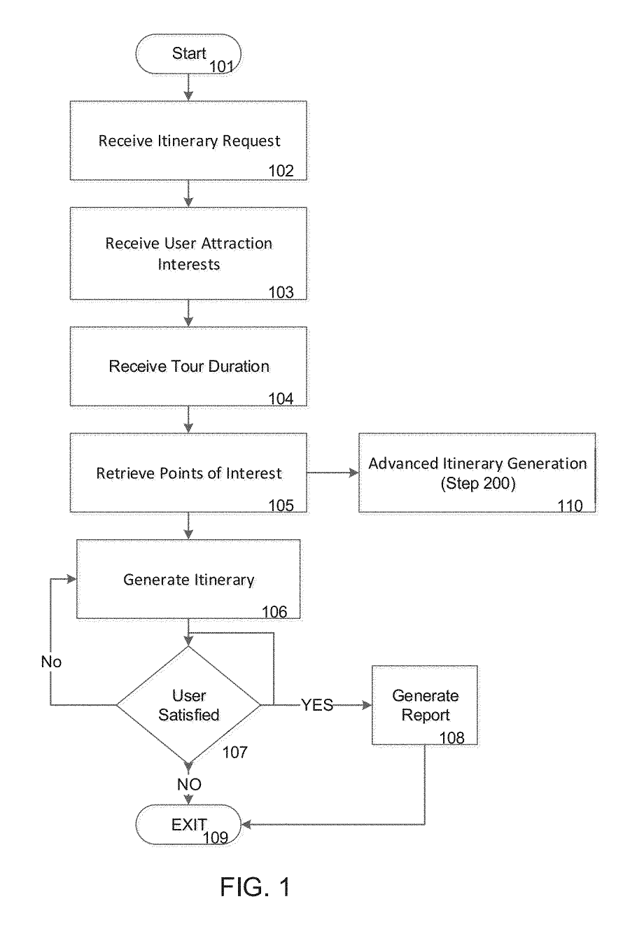

Turning now to FIG. 1, an exemplary process in accordance with an embodiment of the present invention is shown. In this FIG. 1, the process starts at step 101 with the user engaging the system for the purpose of having an optimal itinerary for a given trip to be generated. At step 102, the system receives an itinerary request from the user. The itinerary request comprises all the information the system needs to begin the itinerary formation process.

At step 103, the system receives the user attraction interests. In preferred embodiments, this will either be retrieved from the itinerary request received from the user at the initiation of the process, or otherwise retrieved from stored information previously provided by the user. In other embodiments, the user attraction interests may be retrieved from third party systems, such as social media accounts or other third party data providers.

At step 104, the system retrieves information about the duration and location of the tour. Similar to the attraction interest information, tour information may be retrieved from the itinerary request, stored information or otherwise provided by third party systems.

At step 105, the system retrieves a plurality of points of interests associated with the user attraction interests information and tour information. The system may retrieve the information from locally or remotely stored storage mediums containing information about various points of interests in the location of the tour and surrounding areas. The system may further augment this locally or remotely stored information with information retrieved from third party systems, such as via an API or other communications means.

Once the system has retrieved the information about the various points of interests and has parsed the tour information and interest information associated with the user, the system may set about generating an optimal itinerary for a tour to be taken by the user or other individual (step 106). As noted above, the process for generating an optimal itinerary may comprise: 1) calculating density clusters for the plurality of points of interests retrieved by the system; 2) processing information related to those points of interests, which may include, but is not limited to, opening time, closing time, best time to visit, duration to complete visit to a point of interest; 3) processing information about transit times and types of transit available between points of interests; and 4) producing a proposed itinerary for user review and confirmation prior to generating the full optimal itinerary.

At step 107, the system may present to the user the proposed itinerary for review and confirmation. If the user is satisfied, the system may generate the full optimal itinerary report (step 108) after which, the full report will be provided to the user and the process will terminate at step 109. Alternatively, if the proposed itinerary is not desirable to the user, the system may be configured to revert back and generate another proposed itinerary for review by the user (revert to step 106).

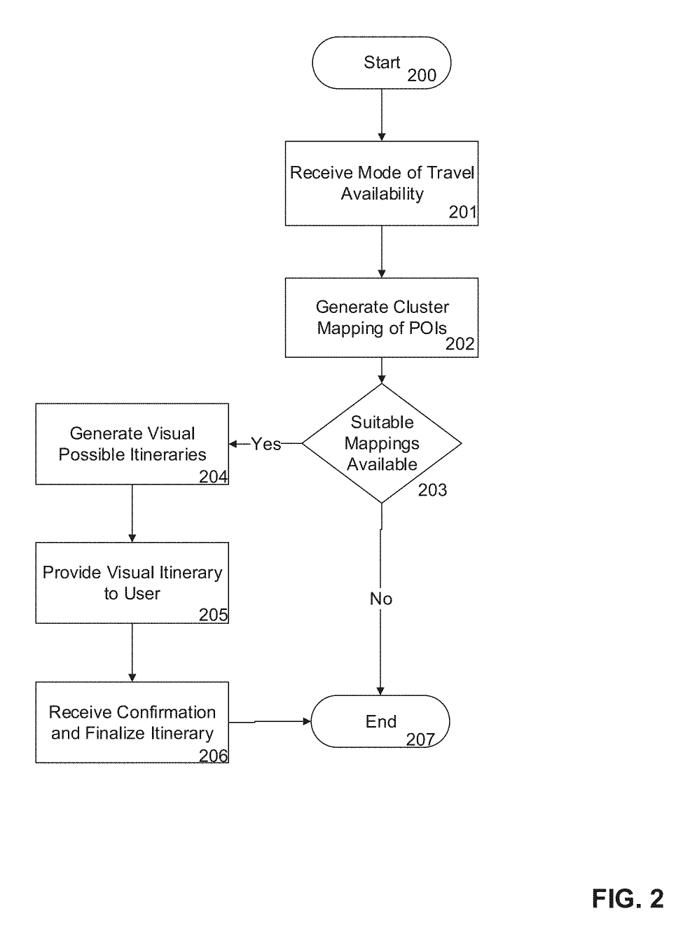

In an optional arrangement of the system, at step 110, the system performs an advanced itinerary generation process (shown in FIG. 2). The advanced generation process of FIG. 2 starts at step 200. Many of the features shown in FIG. 2 are discussed above, but FIG. 2 simply shows the process in greater detail as one might expect in a preferred embodiment of the present invention.

At step 201, the system retrieves modes of transport available between various points of interest. Since not all points of interest may be accessible by certain modes of transport, and certain points of interest may even require more than one mode of transport to reach, retrieving modes of transport between the various points of interest can be very important.

At step 202, the system generates cluster mappings of the various points of interest. Here, the system is preparing a mapping of groups of points of interest based on density in order to identify which locations could be optimal for inclusion in an itinerary to ensure the user is able to enjoy as many points of interest on their tour as possible. Clustering by density is useful to determine POIs close to each other. This is especially helpful to identify clusters of similar type of interest (e.g., shopping). In certain embodiments of the present invention, a density based clustering algorithm (e.g., DBSCAN) could be utilized to identify density regions or clusters based on spatial density. One of ordinary skill in the art would appreciate that there are numerous algorithms that would be appropriate for use for this purpose, and embodiments of the present invention are contemplated for use with any appropriate algorithm.

In certain embodiments, the

At step 203, the system determines if there are suitable POI cluster mappings to allow for generation of optimal itinerary generation for the tour. If there are not enough or if there are no suitable POI cluster mappings, the process will terminate at step 207.

If there are enough suitable POI cluster mappings, the system will generate (step 204) one or more visual possible itineraries. In a preferred embodiment, these are generally what the system would consider ideal itineraries, including the highest number of POIs or otherwise the highest level of matching with the preferences set or identified by the user with respect to POIs desired to be seen on the tour. In this step, the system may identify a highest number of POIs or other best matches via generating a matrix consisting of inter-distance between POIs. The x and y axes of the matrix are the various POIs and distance between the two. The matrix is symmetric across the diagonal and each row is sorted by distance. In a preferred embodiments, this matrix is used in part to generate the possible itineraries, for instance, by generating a trip list or array by adding to the list or array elements from the matrix with the shortest distance from the inter-distance matrix.

In certain embodiments, the trip list or array obtained from the step mentioned above has POIs that have region IDs associated with them from the clustering. The list or array may be reordered by consolidating the region IDs. For instance, the list or array may have the POIs with the same region ID arranged together while otherwise maintaining the order provided from the original list. These POIs that are arranged together may be appended to another list or array, now sorted by Region ID. Now, the system has separate arrays with matching Region IDs which can be used in the process of generating optimal itineraries, since now the system has multiple arrays all arranged based on distance and shared Region IDs.

Once generated, the system will provide the user the visual possible itineraries for review (step 205). Presentation of the visual possible interfaces may be done, for instance, by way of providing a graphical user interface (GUI) for viewing on a computing device operated by the user.

At step 206, the system receives confirmation from the user relating to one or more of the visual possible itineraries. The system will then return to the generation process and formalize and prepare the final optimal itinerary and the process will terminate at 207. In certain embodiments of the present invention, the system may also be configured to allow for the user to input optional or additional POIs not selected by the system or previously provided. In this manner, the system can allow for the user to manually edit provided itineraries, so that they best suit the user's desires. Added optional points may be included and the total trip/tour may be recalculated based on these additional POIs and an updated visual possible itinerary provided to the user. Addition of POIs may violate the total trip time indicated by the user, and the system may be configured to alert the user to any violation of trip time or other parameters violated by the addition of POIs.

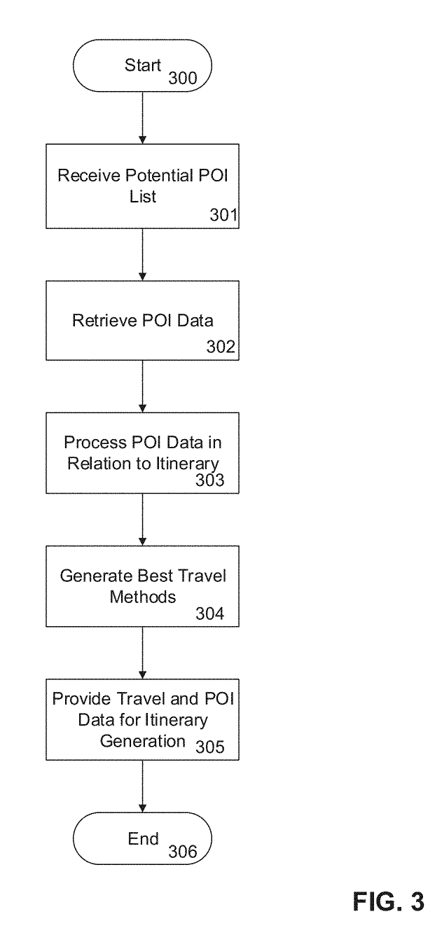

Turning to FIG. 3, a process for improving generation of an optimal itinerary by way of retrieving and utilizing data associated with various POIs is detailed. The process starts at step 300, generally during the processing of an itinerary request. At step 301, the system has determined a number of POIs in a tour area and the module associated with processing POI information is provided a potential POI list.

At step 302, the system parses the POI list and retrieves POI data associated will all available POIs. Not all POIs will have information that is retrievable, but the system is configured to retrieve what available information is has access to, whether locally, remotely or otherwise provided via a third party system. As noted elsewhere, POI data may be related to various aspects of the particular POIs, such as opening time, closing time, average visit duration, best times to visit, least popular times to visit, times of high traffic in the vicinity, times of low traffic in the vicinity, or any combination thereof.

At step 303, the system processes the POI data gathered in relation to the itinerary request provided by the user. Generally, this information is used to help the system determine an optimal itinerary by ensuring that the POIs available are linked and associated in a manner that provides the greatest return on time for the tour. For instance, the system can choose POIs that open early as starting points and further use traffic information to avoid areas where time would be lost due to delays in transport between POIs or otherwise by crowds at particular POIs.

At step 304, the system generates best travel methods for a potential optimal itinerary. For instance, since on many tours, an individual or the user may not be tied to specific modes of travel, there may be more than one type of travel available between two POIs or clusters (e.g., walking, bike, taxi or other car service, subway, train, rental car, boat, ferry). Depending on many variables, like time of day, time of year, available routes between clusters or POIs, or any combination thereof, the system may determine various modes of transportation are the best for a given optimal itinerary.

At step 305, the system provides the travel and POI data for itinerary generation (such as detailed in FIG. 1). At this point, the process terminates at step 306.

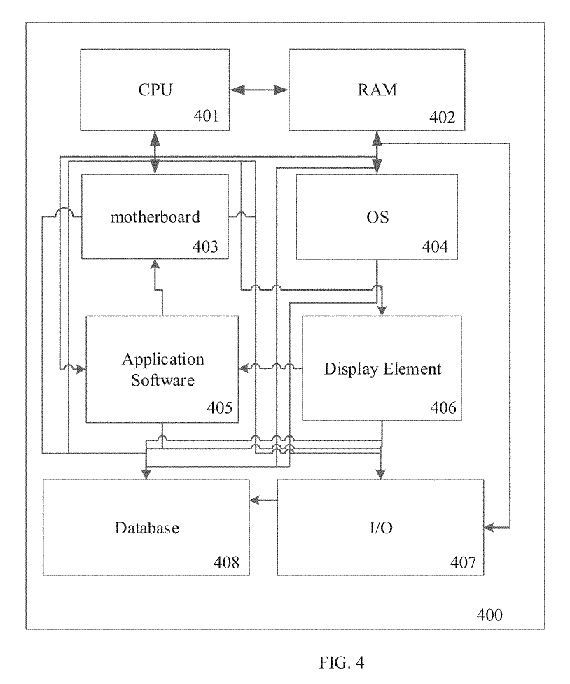

According to an embodiment of the present invention, the system and method may be configured to share and or receive data to and may be used in conjunction or through the use of one or more computing devices. As shown in FIG. 4, One of ordinary skill in the art would appreciate that a computing device 400 appropriate for use with embodiments of the present application may generally be comprised of one or more of a Central processing Unit (CPU) 401, Random Access Memory (RAM) 402, a storage medium (e.g., hard disk drive, solid state drive, flash memory, cloud storage) 403, an operating system (OS) 404, one or more application software 405, one or more display elements 406, one or more input/output devices/means 407 and one or more databases 408. Examples of computing devices usable with embodiments of the present invention include, but are not limited to, personal computers, smartphones, laptops, mobile computing devices, tablet PCs and servers. Certain computing devices configured for use with the system do not need all the components described in FIG. 4. For instance, a server may not necessarily include a display element. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

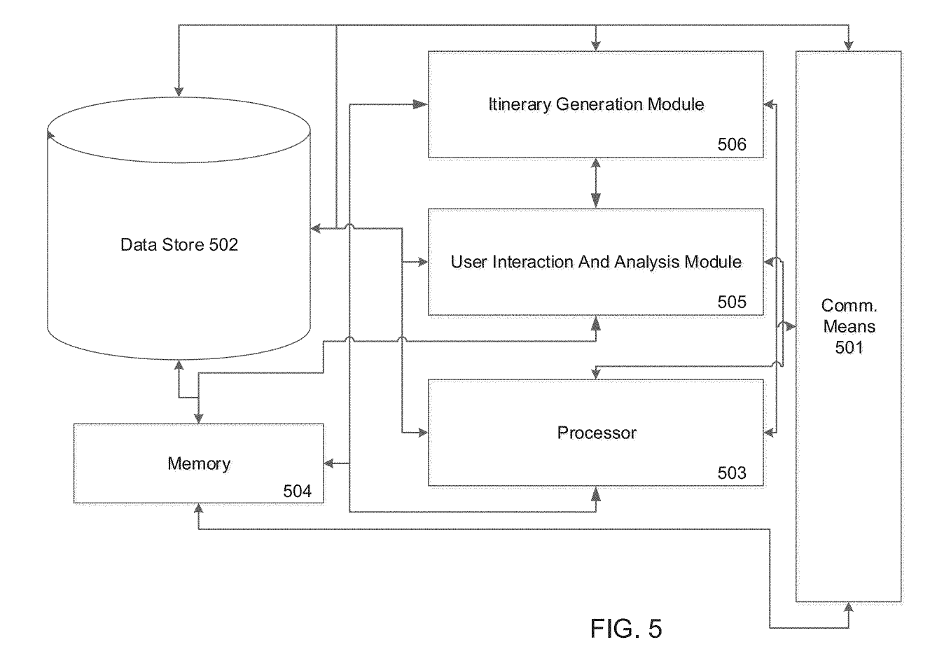

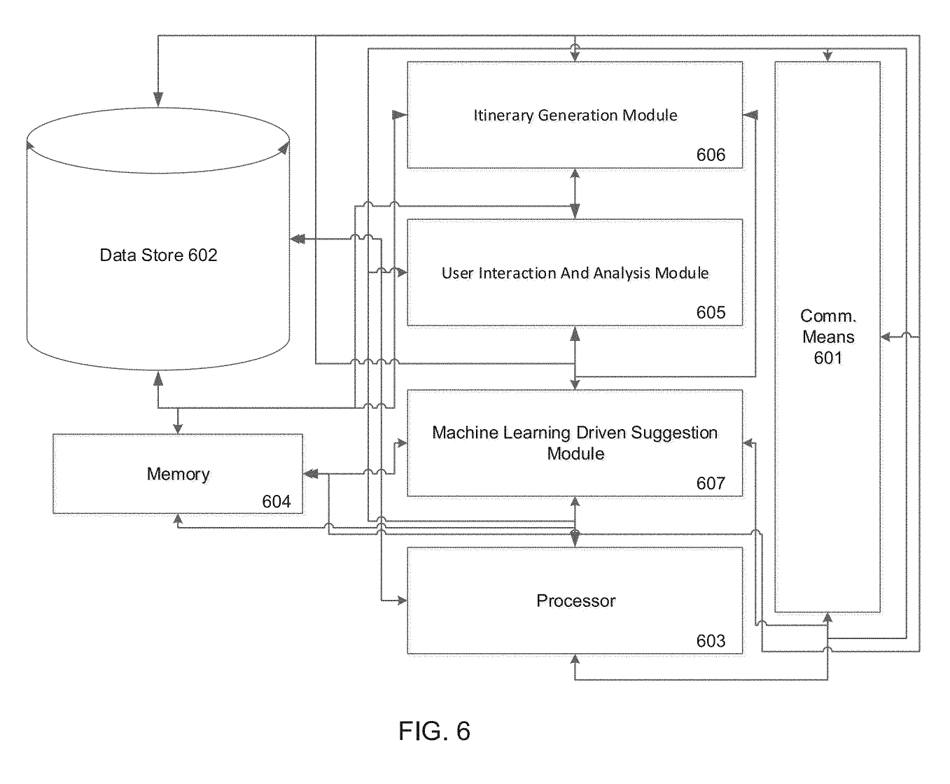

Turning to FIG. 5, according to an embodiment of the present invention, a system for generating travel itineraries based on user interests is comprised of one or more communications means 501, one or more data stores 502, a processor 503, memory 504, a User Interaction and Analysis module 505 and Itinerary Generation module 506. FIG. 6 shows an alternative embodiment of the present invention, comprised of one or more communications means 601, one or more data stores 602, a processor 603, memory 604, an Interaction and Analysis module 605 and Itinerary Generation module 606 and a Machine Learning Driven Suggestion module 607. The various modules described herein provide functionality to the system, but the features described and functionality provided may be distributed in any number of modules, depending on various implementation strategies. One of ordinary skill in the art would appreciate that the system may be operable with any number of modules, depending on implementation, and embodiments of the present invention are contemplated for use with any such division or combination of modules as required by any particular implementation. In alternate embodiments, the system may have additional or fewer components. One of ordinary skill in the art would appreciate that the system may be operable with a number of optional components, and embodiments of the present invention are contemplated for use with any such optional component.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

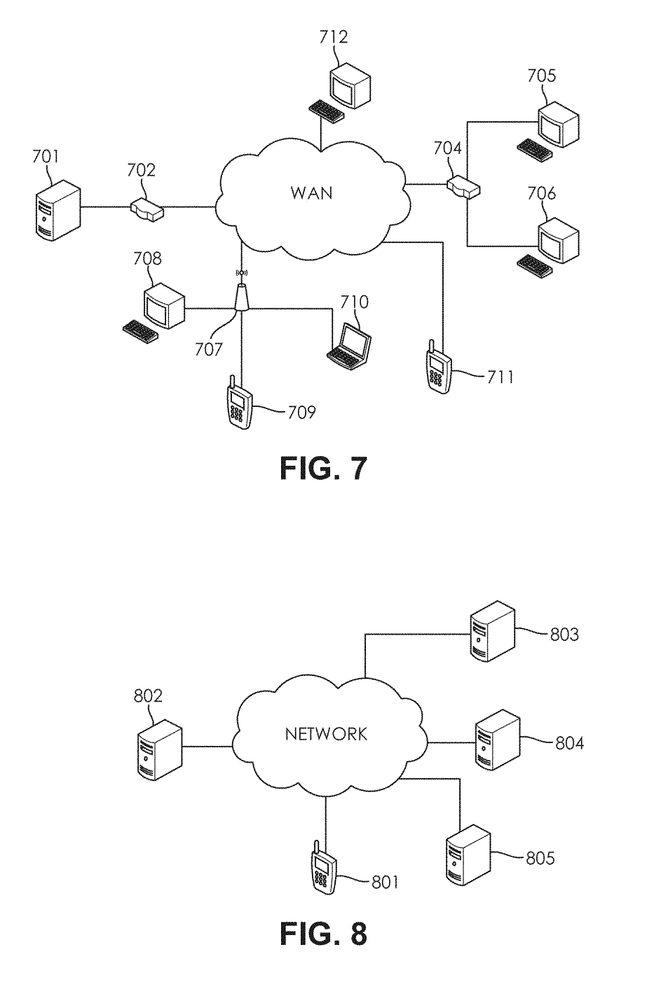

Referring to FIG. 7, a schematic overview of a cloud based system in accordance with an embodiment of the present invention is shown. The cloud based system is comprised of one or more application servers 703 for electronically storing information used by the system. Applications in the application server 203 may retrieve and manipulate information in storage devices and exchange information through a Network 701 (e.g., the Internet, a LAN, WiFi, Bluetooth, etc.). Applications in server 703 may also be used to manipulate information stored remotely and process and analyze data stored remotely across a Network 701 (e.g., the Internet, a LAN, WiFi, Bluetooth, etc.).

According to an exemplary embodiment, as shown in FIG. 7, exchange of information through the Network 701 may occur through one or more high speed connections. In some cases, high speed connections may be over-the-air (OTA), passed through networked systems, directly connected to one or more Networks 701 or directed through one or more routers 702. Router(s) 702 are completely optional and other embodiments in accordance with the present invention may or may not utilize one or more routers 702. One of ordinary skill in the art would appreciate that there are numerous ways server 703 may connect to Network 701 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 703 via Network 701 or other network in numerous ways. For instance, a component may connect to the system i) through a computing device 712 directly connected to the Network 701, ii) through a computing device 705, 706 connected to the WAN 701 through a routing device 704, iii) through a computing device 708, 709, 710 connected to a wireless access point 707 or iv) through a computing device 711 via a wireless connection (e.g., CDMA, GMS, 3G, 4G) to the Network 701. One of ordinary skill in the art would appreciate that there are numerous ways that a component may connect to server 703 via Network 701, and embodiments of the present invention are contemplated for use with any method for connecting to server 703 via Network 701. Furthermore, server 703 could be comprised of a personal computing device, such as a smartphone, acting as a host for other computing devices to connect to.

Turning now to FIG. 8, a continued schematic overview of a cloud based system in accordance with an embodiment of the present invention is shown. In FIG. 8, the cloud based system is shown as it may interact with users and other third party networks or APIs. For instance, a user of a mobile device 801 may be able to connect to application server 802. Application server 802 may be able to enhance or otherwise provide additional services to the user by requesting and receiving information from one or more of an external content provider API/website or other third party system 803, a document storage system 804, one or more additional POI information services 805 or any combination thereof. Additionally, application server 802 may be able to enhance or otherwise provide additional services to an external content provider API/website or other third party system 803, a document storage system 804, one or more additional POI information services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

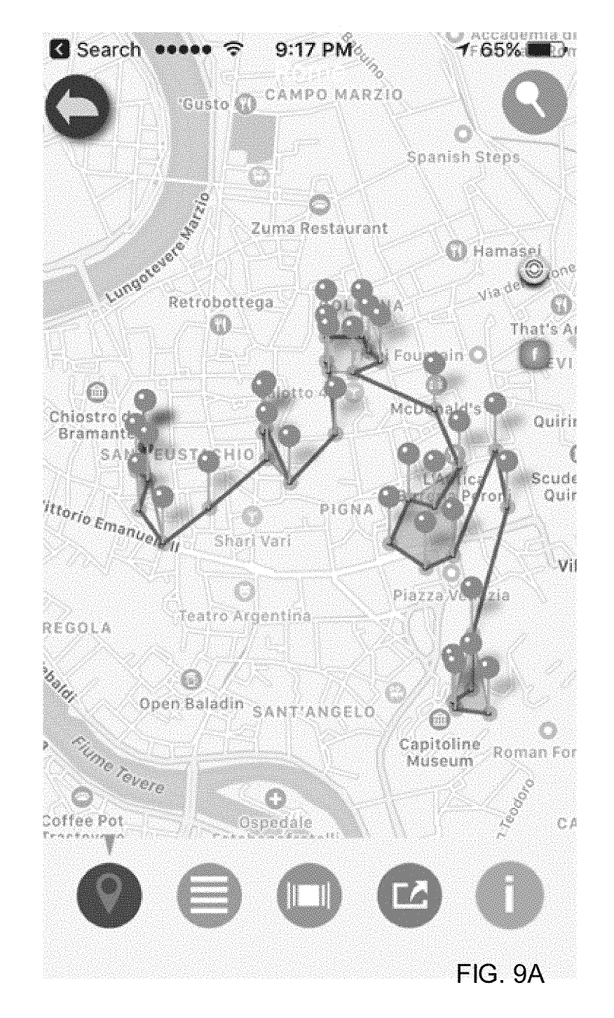

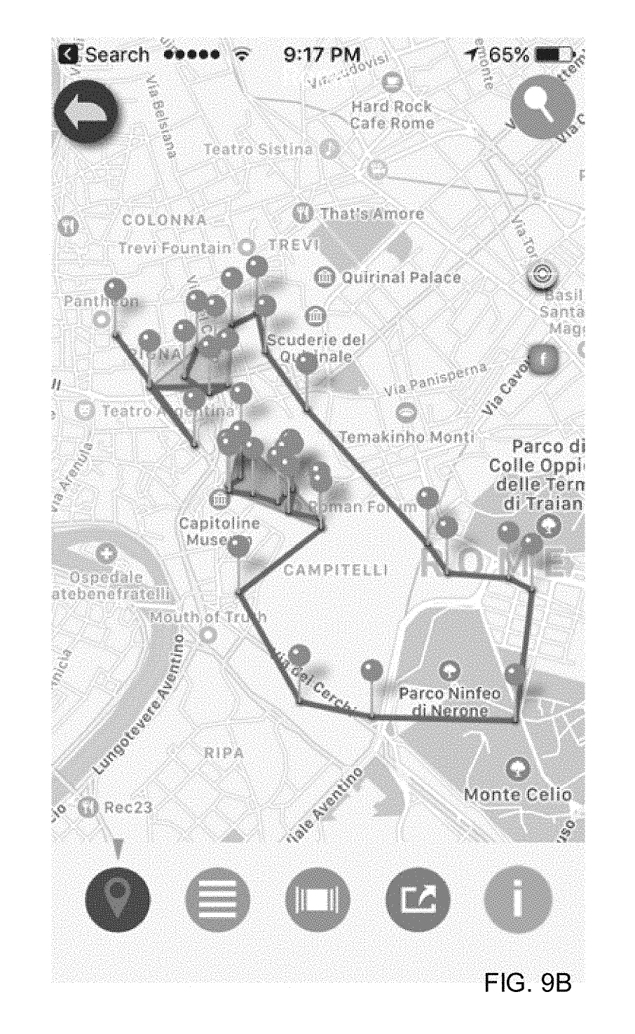

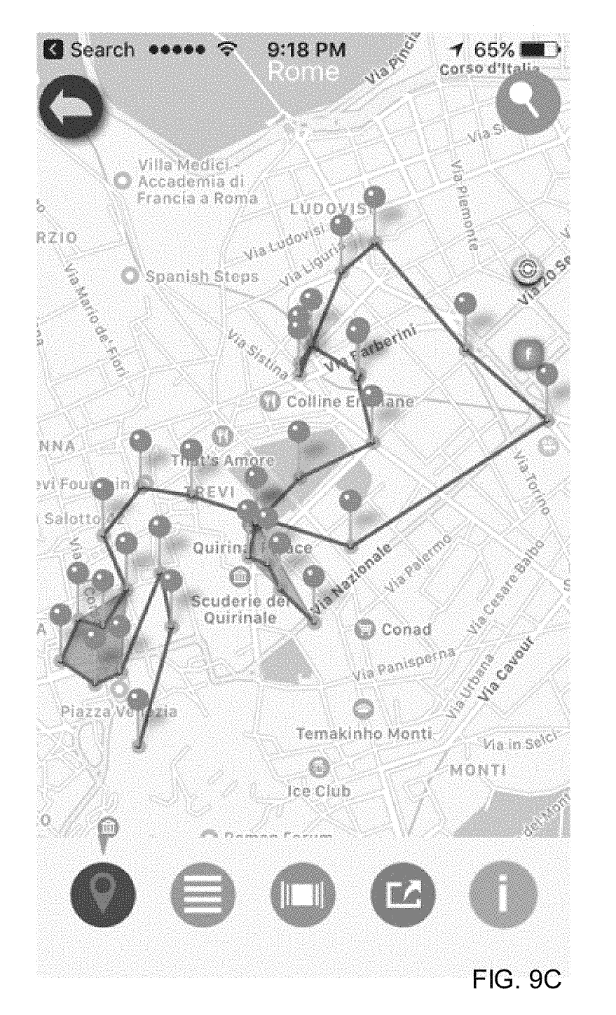

Turning now to FIGS. 9A-9C, exemplary embodiments of graphical user interfaces depicting an optimal itinerary generated by an embodiment of the present invention are shown. In FIGS. 9A-9C, an optimal itinerary for Rome is shown. The pins represent specific POIs that have been selected and the dark line shows an optimal route for moving between the POIs. It should be noted and apparent via these graphical user interfaces that the density of the clusters of the POIs provide for an optimal itinerary, maximizing the amount of POIs a user would be able to visit in a single tour.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for generating travel itineraries based on user interests, said system comprising:
a computer processor;
a non-volatile computer-readable memory; and
a data receiving interface,
wherein the non-volatile computer-readable memory is communicatively connected to said processor and data receiving interface and is configured with computer instructions configured to:
receive an itinerary generation request from a user;
process a set of one or more user attraction interests from said itinerary generation request;
process a tour duration from said itinerary generation request, wherein said tour duration indicates the temporal duration of a tour to be taken by said user at a future time;
retrieve a plurality of potential points of interests, wherein each potential point of interest in said plurality of points of interest corresponds to at least one user attraction interest of said set of one or more user attraction interests;
generate a plurality of point of interest clusters based on said plurality of potential points of interests;
generate near best distance solution between said plurality of points of interest clusters;
generate a preferred itinerary, based at least in part on said near best distance solution; and
transmitting said preferred itinerary to said user.

2. The system of claim 1, wherein the non-volatile computer-readable memory is further configured with computer instructions configured to:
identify one or more modes of travel associated with said itinerary generation request,
wherein said one or more modes of travel are utilized in generating said preferred itinerary.

3. The system of claim 2, wherein said one or more modes of travel are utilized to identify best methods of travel between one or more of said plurality of point of interest clusters.

4. The system of claim 1, wherein the non-volatile computer-readable memory is further configured with computer instructions configured to:
generate one or more visual possible itineraries based at least in part on said near best distance solution;
provide said one or more visual possible itineraries to said user;
receive from the user a selected visual possible itinerary from said user, wherein said selected visual possible itinerary was selected from said one or more visual possible itineraries; and
utilize said selected visual possible itinerary in generation of said preferred itinerary.

5. The system of claim 1, wherein the non-volatile computer-readable memory is further configured with computer instructions configured to retrieve additional information about one or more of said potential points of interest.

6. The system of claim 5, wherein additional information about one or more said potential points of interest comprises, hours of operation, best times to visit, popular times to visit, dress code, expense, access to public transit, special offers and average duration of visit.

7. The system of claim 5, wherein the non-volatile computer-readable memory is further configured with computer instructions configured to eliminate one or more potential points of interests from said plurality of potential points of interests.

8. The system of claim 5, wherein the non-volatile computer-readable memory is further configured with computer instructions configured to organize said preferred itinerary based in part on said additional information about one or more said potential points of interest.

9. The system of claim 1, wherein the non-volatile computer-readable memory is further configured with computer instructions configured to generate a convex hull that is used for visualizing the boundaries of the previously generated points of interest clusters.

10. A method for generating travel itineraries based on user interests, said method comprising the steps of:
receiving an itinerary generation request from a user;
processing a set of one or more user attraction interests from said itinerary generation request;
processing a tour duration from said itinerary generation request, wherein said tour duration indicates the temporal duration of a tour to be taken by said user at a future time;
retrieving a plurality of potential points of interests, wherein each potential point of interest in said plurality of points of interest corresponds to at least one user attraction interest of said set of one or more user attraction interests;
generating a plurality of point of interest clusters based on said plurality of potential points of interests;
generating near best distance solution between said plurality of points of interest clusters;
generating a preferred itinerary, based at least in part on said near best distance solution; and
transmitting said preferred itinerary to said user.

11. The method of claim 10, further comprising the step of:
identifying one or more modes of travel associated with said itinerary generation request,
wherein said one or more modes of travel are utilized in generating said preferred itinerary.

12. The method of claim 11, wherein said one or more modes of travel are utilized to identify best methods of travel between one or more of said plurality of point of interest clusters.

13. The method of claim 10, further comprising the steps of:
generating one or more visual possible itineraries based at least in part on said near best distance solution;
providing said one or more visual possible itineraries to said user;
receiving from the user a selected visual possible itinerary from said user, wherein said selected visual possible itinerary was selected from said one or more visual possible itineraries; and
utilizing said selected visual possible itinerary in generation of said preferred itinerary.

14. The method of claim 10, further comprising the step of retrieving additional information about one or more of said potential points of interest.

15. The method of claim 14, wherein additional information about one or more said potential points of interest comprises, hours of operation, best times to visit, popular times to visit, dress code, expense, access to public transit, special offers and average duration of visit.

16. The method of claim 14, further comprising the step of eliminating one or more potential points of interests from said plurality of potential points of interests.

17. The method of claim 14, further comprising the steps of organizing said preferred itinerary based in part on said additional information about one or more said potential points of interest.

18. The method of claim 10, further comprising the step of generating a convex hull that is used for visualizing the boundaries of the previously generated points of interest clusters.
